(19) United States
(12) Patent Application Publication
(10) Pub. No.: US 2003/0005196 A1
(43) Pub. Date: Jan. 2, 2003

(54) Apparatus and methods for using USB in programmable logic controllers

(76) Inventor: Richard E. Reed, Charlottesville, VA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,971

(22) Filed: Jul. 2, 2001

(51) Int. Cl. G06F 13/00

(52) U.S. Cl. 710/300

(57) ABSTRACT

A programmable logic controller (PLC) includes a central processing unit (CPU), at least one input/output (I/O) module and a communications interface between the CPU and the I/O module. The communications interface incorporates a universal serial bus (USB) protocol to create a standard, open interface providing a low cost, reliable communication link.

### BACKGROUND OF INVENTION

This invention relates generally to communications between controllers and modules and, more specifically, to communications within programmable logic controller (PLC) systems.

PLCs have a variety of configurations, including rack mounted I/O systems. The racks provide mechanical/electrical connection slots for power supply, CPU boards, and controlled I/O modules, which provide interfaces to external devices to be controlled. In a rack system, the CPU communicates across a fixed size backplane in a main rack with local I/O modules. In many applications, more I/O modules are needed than can fit in the main control rack. Therefore, expansion racks, or multiple expansion racks, are used to hold additional I/O modules. A communication link also exists between the main rack which includes the CPU and the expansion racks to allow data transfers between all I/O modules in the application and the main rack CPU.

Other PLC systems incorporate modular configurations which allows a CPU to interconnect to a varying number of I/O modules through a common connector interface, extending the backplane communication as each I/O base is added to the previous module. This allows flexibility in installation since there is not a fixed size, as in the rack systems. The I/O modules provide different functionalities to the PLC system but all use a common communication scheme passed through the module bases. Modular systems, also, do not have to be singularly interconnected but may use a communication link between groups of interconnected modular I/O. The modular system communication link is similar to the expansion rack communication links with the main CPU controlling the flow of data to all modular I/O groups either directly through the common base connectors and through the communication cable link to an expansion grouping, or groupings, of I/O modules.

PLC systems require reliable data transfer methods to move data back and forth between the CPU and the I/O modules. With such a requirement, PLC systems need reliable error detection. Since most PLC systems are produced in large quantities, it is desirable that the communications interface be inexpensive. Further, some known PLC systems also have I/O modules that can be removed and inserted while the PLC system is powered, commonly referred to as hot-insertion and removal. Hot-insertion and removal allows the I/O modules to be replaced without shutting down the system. Also, for a PLC system to be economically viable, the functionality described above should be delivered at a minimal cost, at a minimal size and include readily available cabling. For ease of use, insertion of I/O modules should cause the CPU to auto configure the PLC system as I/O modules are added to the system. Further, upon power application the CPU should auto configure the PLC system.

Known PLC systems incorporate many different proprietary and standard communication protocols and configurations for communications between a CPU of a PLC and I/O modules and PLC expansion racks or groups. Known industrial communications standards are still evolving, and include many different standards.

### SUMMARY OF INVENTION

The present invention is, in one aspect, a programmable logic controller (PLC) which includes a central processing unit (CPU), at least one input/output (I/O) module and a communications interface between the CPU and the I/O module(s), the communications interface incorporating a universal serial bus (USB) protocol. The communications interface can be placed in one or more of a rack backplane, or a modular backplane that interconnects I/O modules directly, or through interconnecting cables to wherever I/O modules are mounted. The interface allows the CPU to communicate directly with the I/O modules using USB protocol.

In other aspects, the USB interface provides a data communication link between main and expansion racks or expansion I/O groups, allowing more flexibility in installing the control system with existing non-USB supporting I/O modules. USB providing the standard communication link to allow rack I/O, modular I/O, and I/O modules with integrated USB support to be supported in any mix by a single CPU.

In other aspects of the invention, I/O units and I/O modules incorporate USB interfacing for connection to a USB port of any CPU. This allows for I/O control without having to use an embedded PLC CPU, but rather I/O module control using any computer CPU that supports USB. In another aspect, there is described a method of using USB communications protocols to control and monitor performance of I/O modules.

### BRIEF DESCRIPTION OF DRAWINGS

FIG. 1 is a pictorial view of a rack PLC system.

FIG. 2 is a pictorial view of a modular PLC system.

FIG. 3 is a view of stand alone USB slave I/O modules.

FIG. 4 is a modular PLC system based on a USB link and stand alone USB slave I/O modules.

FIG. 5 is a PLC system using USB for expansion rack and I/O control.

FIG. 6 is an example of using a generic PC to control USB slave I/O modules and an expansion I/O grouping.

### DETAILED DESCRIPTION

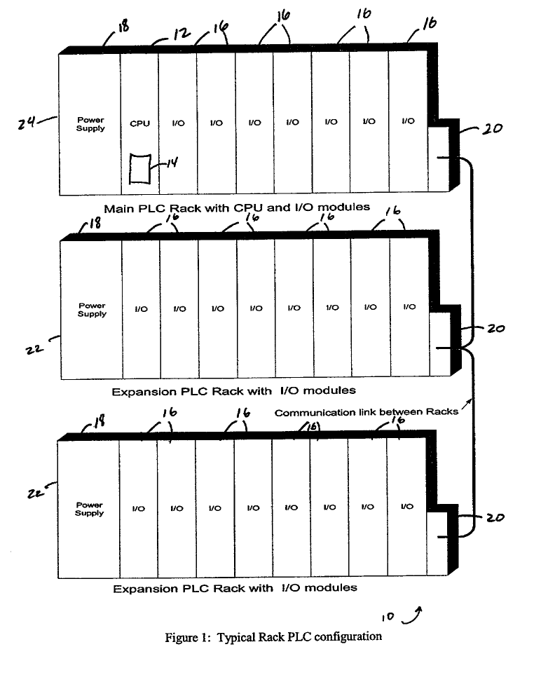

FIG. 1 is a block diagram of a PLC 10 according to one embodiment of the present invention. PLC 10 includes a central processing unit (CPU) 12, with embedded memory 14, a plurality of Input/Output (I/O) units 16, power supplies 18 and communications interfaces 20. PLC system 10 further includes multiple racks 22 to support I/O modules 16 in addition to I/O modules within main rack 24. Although multiple I/O units 16 in multiple racks 22 and 24 are shown in FIG. 1, PLC 10 may include only one I/O unit 16, for example, an I/O unit for interfacing to a motor, or an I/O unit for receiving various input signals from devices, i.e., a switch (not shown). In addition, PLC 10 may include only one of racks 22 and 24. I/O units 16, in operation, typically are coupled to one or more external devices (not shown). A user program (not shown) is stored in memory 14. The user program controls operation of CPU 12 so that based at least in part on inputs from external devices, read by I/O units 16, appropriate outputs to external devices, from I/O unit 16 are generated. Specifically, control and data signals (not shown) are bidirectionally coupled between CPU 12 and I/O units 16. The signals are utilized to exchange information between CPU 12 and I/O units 16. Information is exchanged between I/O units 16 and external devices using various means, for example individual wires and multiple conductor cables. In addition, certain external devices typically have integrated wires or cables to be coupled to I/O units 16. Communications interfaces 20 are configured to provide communications between CPU 12 in main rack 24 and I/O units 16 in expansion racks 22, thereby allowing for CPU control of all I/O units 16 with CPU 20. In one embodiment, communications interfaces 20 are configured as USB interfaces.

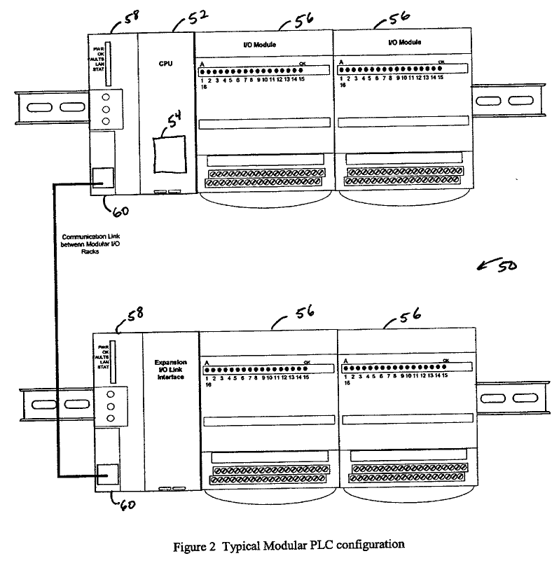

FIG. 2 is a pictorial diagram of a PLC system 50, which includes a CPU 52 with an embedded memory 54, I/O modules 56, and power supplies 58. System 50 provides similar functionality to system 10 (shown in FIG. 1). However system 50 is configured to be modular. CPU 52 and I/O modules 56 plug together to create a single PLC group and I/O modules 56 are interchangeable to create flexible I/O module groupings, dependent upon a specific application PLC system 50 is supporting. PLC system 50 further includes communications interfaces 60 which, as in system 10, allow a single CPU to control grouping of I/O modules which are located at separate locations.

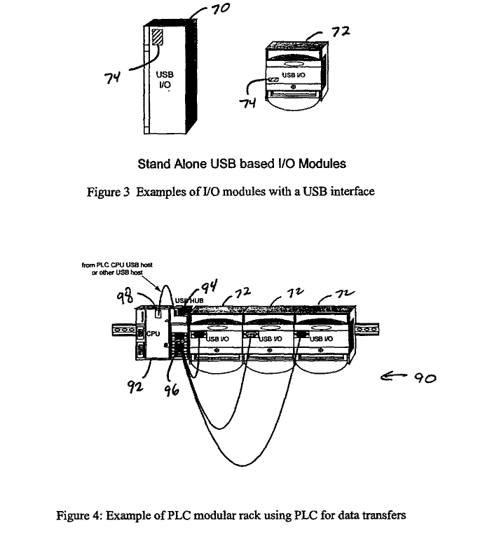

FIG. 3 shows I/O modules 70 and 72 which are configured with a slave USB port as its data communication link to the host CPU. Rather than providing communications interfaces 20 and 60 as shown in FIGS. 1 and 2 respectively, I/O modules 70 and 72 are configured with a USB interface 74 which allows for CPU control of each of I/O modules 70 and 72 directly. In alternative embodiments, USB interface 74 is configured as a Universal Serial Bus (USB) connector, either series A, series B, or mini series B.

FIG. 4 shows a PLC system 90, which incorporates I/O modules 72 (shown in FIG. 3). System 90 is similar to system 50 (shown in FIG. 2), but I/O modules 72 communicate with CPU 92 through a USB cabling arrangement. System 90 differs from system 50 in that, I/O modules 56 (shown in FIG. 2) are configured for both mechanical and electrical attachment of I/O bases, into which I/O modules are installed. In system 90 a USB hub 94 provides a USB interface 96 from CPU 92 to each of I/O modules 72. In alternative embodiments, CPU connector 98, and USB interface 96 are configured as Universal Serial Bus (USB) connectors, either series A, series B, or mini series B.

Universal Serial Bus (USB) has become a standard in the personal computer industry. USB is advantageous over other computer interfaces because up to 127 devices can be supported on one port and USB supplies power to the peripherals, reducing the need for additional power supplies. Further, depending on the speed of the peripheral, USB supports communications at 1.5 Mbps, 12 Mbps and in some cases up to 480 Mbps. In another embodiment, USB incorporates a tiered star topology. In addition, USB devices can be adding during system operation. USB also eliminates problems encountered with existing peripheral additions, such as cabling, for example, null modem cables and handshaking lines. Also, USB devices are configured with slave ports for communications with a host port of the CPU. USB supports four different data transfer types:- isochronous, control, interrupt, and bulk. Most CPUs being produced support USB, including those being used as the CPUs for PLC systems. Further, USB allows placement of I/O modules up to five meters apart.

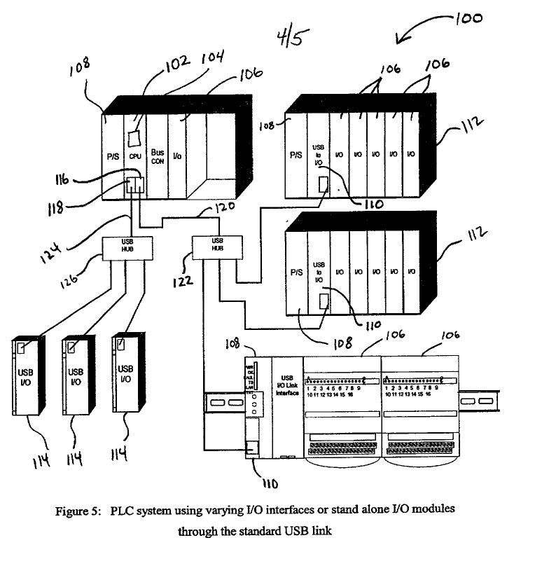

FIG. 5 is a block diagram view of a PLC system 100 incorporating USB where the CPU and I/O modules are interconnected via USB cabling. System 100 includes a central processing unit (CPU) 102, an embedded memory 104, a plurality of Input/Output (I/O) units 106, power supplies 108, communications interface 110, I/O expansion racks 112 and stand alone I/O modules 114. CPU 102 includes USB connectors 116 and 118. USB connector 116 is attached to a USB cable 120, which is connected to a USB hub 122. Hub 122 provides a USB interface from CPU 102 to I/O expansion racks 112 and communications interface 110, thus allowing CPU 102 to control all I/O units 106. USB connector 118 is attached to a USB cable 124 that is connected to a USB hub 126. Hub 126 provides a USB interface from CPU 102 to stand alone I/O modules 114, thereby allowing CPU 102 to control stand alone I/O modules 114. In alternative embodiments, USB connectors 116 and 118 are configured as Universal Serial Bus connectors, either series A, series B, or mini series B. In one exemplary embodiment, communications interface 110 is configured as Universal Serial Bus (USB) connector. USB cables 120 and 124 are configurable, in one embodiment, to be up to five meters long.

In another embodiment, not shown, a PLC is configured with an I/O rack for connecting the CPU to the individual I/O modules. In such an embodiment, the I/O rack is configured to facilitate communication between the CPU and the I/O modules by incorporating a USB interface into the I/O rack. The CPU and the I/O modules interface to the USB when inserted into the I/O rack. In such an embodiment, the CPU is incorporated into the I/O rack.

In a further alternative embodiment, the CPU is located separate from the I/O rack. The I/O rack incorporates USB slave ports as part of a backplane for communication with one or more I/O modules inserted into the I/O rack and the I/O rack provides a USB interface for one or more external USB devices, one being a CPU module. Designing USB into the I/O rack minimizes cabling requirements between USB compatible modules while still utilizing the open communications standards of USB. Such a design allows a single cable between a CPU module and an I/O rack. An I/O rack configured as a USB slave port is further configured to perform local I/O scanning and report data from all I/O modules in one or more series of messages to and from the CPU module.

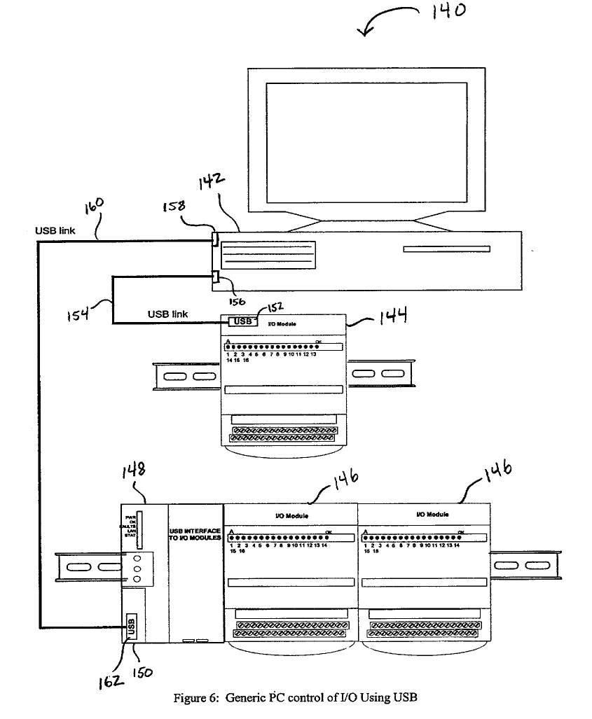

FIG. 6 is a block diagram view of a personal computer (PC) system 140 incorporating USB where the PC and I/O modules are interconnected via USB cabling. System 140 includes a PC 142, multiple Input/Output (I/O) units 144 and 146, a power supply 148 and a communications interface 150. I/O unit 144 includes a USB connector 152, which is connected to a USB cable 154. USB cable 154 is connected to a USB connector 156 on PC 142 thereby allowing PC 142 to control I/O unit 144. PC 142 also includes a USB connector 158, which is connected to a USB cable 160. USB cable 160 is connected to a USB connector 162 on communications interface 150 thereby allowing PC 142 to control I/O units 146. In alternative embodiments, USB connectors 152, 156, 158 and 162 are configured as Universal Serial Bus connectors, either series A, series B, or mini series B. In one exemplary embodiment, communications interface 150 is configured as Universal Serial Bus (USB) connector. USB cables 154 and 160 are configurable, in one embodiment, to be up to five meters long.

USB is a common communication standard and is incorporated into many known CPU designs. In incorporating open communications standards, USB is used for implementing hardware communications and controls, without drawbacks of known PLC proprietary communications platforms. In addition, use of USB allows interfacing of I/O modules to multiple CPUs, provided that software drivers for each of the individual I/O modules are installed with the CPU to be connected to. In such embodiments, such as the example shown in FIG. 6, I/O modules or racks incorporating I/O modules are compatible with CPU modules from multiple suppliers, due to the open communications standards of USB, thereby providing a user with portability options between multiple PLC systems.

While the invention has been described in terms of various specific embodiments, those skilled in the art will recognize that the invention can be practiced with modification within the spirit and scope of the claims.

1. A programmable logic controller (PLC) comprising:
a central processing unit (CPU);
at least one input/output (I/O) module; and
a communications interface between said CPU and said at least one I/O module, said communications interface incorporating a universal serial bus (USB) protocol.

2. A PLC according to claim 1 wherein said CPU is configured as a USB host.

3. A PLC according to claim 2 wherein said CPU comprises at least one USB port.

4. A PLC according to claim 3 wherein said I/O module is connected with a tiered star topology.

5. A PLC according to claim 1 wherein said I/O modules are configured with USB slave ports.

6. A PLC according to claim 1 comprising standard USB hub and cabling for connecting said CPU to said I/O modules.

7. A PLC according to claim 1 further comprising an I/O rack for connecting said CPU to said I/O modules, said rack configured to facilitate communication between said CPU and said I/O rack by embedding a USB interface into a rack backplane.

8. A PLC according to claim 1 wherein said communications interface is configured to operate at at least one of 1.5 MBPS and 12 MBPS currently but allowed to expand to future supported data transfer rates according to the USB standards.

9. An I/O unit for a PLC system comprising:
at least one connector for coupling to an external device;
at least one connector for coupling to existing I/O modules (existing normal I/O modules, either rack or modular in nature); and
a connector for coupling to a CPU, said connector comprising a slave USB interface.

10. A connector for coupling to a CPU according to claim 9, said connector for coupling to a CPU comprising at least one of a USB series A connector, a USB series B connector and a USB mini-series B connector.

11. An I/O unit according to claim 9 further comprising a connector for coupling to other I/O units, wherein the other I/O units communicate through the I/O unit in claim 9 to a CPU through the connector in claim 10, said connector comprising a USB interface.

12. An I/O unit according to claim 9 said connector for coupling to a CPU comprising at least one of a USB series A connector, a USB series B connector and a USB mini-series B connector.

13. An I/O module for a PLC system comprising:
a circuit configured to interface to an external I/O device; and
a circuit configured to interface to a USB bus.

14. An I/O module according to claim 13 wherein said circuit configured to interface to a USB bus is configured as a USB slave port.

15. An I/O module according to claim 13 wherein said circuit configured to interface to a USB bus is configured to communicate at at least one of 1.5 MBPS, 12 MBPS, and 480 MBPS.

16. An I/O module according to claim 13 wherein said circuit configured to interface to a USB bus is configured to be inserted and removed from a turned on PLC system.

17. An I/O module according to claim 13 wherein said circuit configured to interface to a USB bus is configured with a tiered star topology.

18. A method for incorporating a communications protocol into a PLC system, said method comprising the steps of:
providing a PLC system CPU with at least one USB host port;
configuring at least one I/O module as a USB slave port; and
connecting the PLC system CPU to the I/O module using a USB interface.

19. A method according to claim 18 wherein the PLC system CPU is configured to communicate on said USB interface at least one of 1.5 MBPS and 12 MBPS.

20. A method according to claim 18 wherein said I/O module is configured to be inserted and removed from a turned on PLC system.

21. A method according to claim 18 wherein the PLC system CPU is configured to support a tiered star topology.
